(19) United States
(12) Patent Application Publication
(10) Pub. No.: US 2013/0021371 A1
(43) Pub. Date: Jan. 24, 2013

(54) IMAGE DISPLAY APPARATUS AND IMAGE DISPLAY METHOD

(71) Applicants: Akira Ueno, Tokyo (JP); Masami Shimamura, Hanno-shi (JP)

(72) Inventors: Akira Ueno, Tokyo (JP); Masami Shimamura, Hanno-shi (JP)

(73) Assignee: OLYMPUS CORPORATION, Tokyo (JP)

(21) Appl. No.: 13/553,028

(22) Filed: Jul. 19, 2012

(30) Foreign Application Priority Data
Jul. 22, 2011 (JP) 2011-160899

(51) Int. Cl. G09G 5/00; G06T 1/00

(52) U.S. Cl. 345/629; 345/522

(57) ABSTRACT

An image display apparatus, which displays a display image obtained by graphically processing an input image stored in an image storage unit connected to a common bus, may include a graphic processing unit that has a function of performing a first and second graphic processes for processing the input image, the graphic processing unit outputting any one of an image obtained by performing the first graphic process on the input image acquired from the image storage unit and an image obtained by performing the second graphic process subsequently to the first graphic process to the image storage unit as a processed image so that the image storage unit stores the processed image, a display processing unit, and a switching control unit that switches a processing unit for performing the second graphic process to any one of the graphic processing unit and the display processing unit based on a predetermined condition.

### BACKGROUND OF THE INVENTION

1. Field of the Invention

The present invention relates to an image display apparatus and an image display method.

Priority is claimed on Japanese Patent Application No. 2011-160899, filed Jul. 22, 2011, the content of which is incorporated herein by reference.

2. Description of the Related Art

All patents, patent applications, patent publications, scientific articles, and the like, which will hereinafter be cited or identified in the present application, will hereby be incorporated by reference in their entirety in order to describe more fully the state of the art to which the present invention pertains.

In recent years, digital equipment such as digital cameras and televisions have been displaying graphical user interfaces (GUIs) using animation and the like. Particularly, portable terminals and the like known as smart phones are provided with dedicated graphic processors to implement elaborate displays.

The main functions of the graphic processor are as follows:

(1) Polygon Process

(2) Superimposition Process

(3) Hidden Surface Process

(4) Shading Process

According to the polygon process, a stereoscopic shape is subdivided into a plurality of polygons (mainly triangles), coordinates of apexes of the polygons are expressed as coordinates of a three-dimensional space, and the coordinates are changed to deform the shapes of the polygons, resulting in the generation of an image of a two-dimensional space in which the movement of the stereoscopic shape is expressed. Furthermore, according to the superimposition process, a plurality of images are synthesized to generate one image and a complete transparent or translucent image is processed, which includes a so-called alpha blending process. Furthermore, according to the hidden surface process, an image of a shadowy and unseen part is processed to generate an image having depth. Furthermore, according to the shadowing process, a shadow or luster is added to an object to obtain a stereoscopic effect.

Japanese Unexamined Patent Application, First Publication No. 2002-352267 discloses technology for an image processing apparatus having the above functions. Furthermore, a graphic processor having the above functions is provided, so that it is possible to provide a system or equipment capable of implementing display having greater appeal. For example, a digital camera is provided with the graphic processor, so that it is possible to perform a slide show function of attractively displaying photographed images.

According to a slide show function in which an image display apparatus such as a digital camera reads a plurality of images recorded on media (recording media) and displays the images on a display device such as thin film transistor (TFT) liquid crystal, the following processes are performed. In addition, according to a series of processes in the digital camera, a memory such as a dynamic random access memory (DRAM) shared by each processing block is used. Furthermore, each processing block provided in the digital camera temporarily stores data being processed in the DRAM, reads data necessary for a subsequent process from the DRAM, and performs respective processes. At this time, each processing block accesses the DRAM through direct memory access (DMA).

(First Process): A plurality of compressed photographed images are read from media and are written to the DRAM.

(Second Process): After the plurality of compressed photographed images stored in the DRAM are read and subjected to an expansion process or an image process, the processed photographed images are written to the DRAM again.

(Third Process): A graphic processor provided in the digital camera reads the processed photographed images stored in the DRAM, a background image, and the like, generates images for display (display images) after a desired process, and writes the display images to the DRAM again.

(Fourth Process): A display processing unit provided in the digital camera reads the display images stored in the DRAM, and displays the display images on the display device.

As described above, according to the image display apparatus such as a digital camera, access of the DRAM by each processing block is frequently performed in the series of processes. Furthermore, the access of the DRAM by each processing block is not sequentially performed in each processing block, and a plurality of processing blocks may simultaneously access the DRAM. Therefore, a band (a DRAM band), which represents the amount of data exchanged between the DRAM and each processing block, should be sufficiently ensured such that a sufficient amount of data necessary for the process of each processing block can be exchanged.

However, when a complicated animation display process is further performed on the display image through the aforementioned polygon process or superimposition process, processes by the graphic processor are further necessary, resulting in an increase in access from the graphic processor to the DRAM. At this time, if the DRAM band is suppressed, since it is not possible for the graphic processor to obtain data necessary for the processes thereof at a desired timing, a long time may be required to generate each display image in animation display. Therefore, the frame rate of the display image may be reduced, resulting in animation display with slow movement.

Hereinafter, a description will be provided for an example of a process when the graphic processor generates the display image. FIG. 9 is a diagram schematically illustrating an example of a display process in an image display apparatus in accordance with the related art. FIG. 9 illustrates each process when six photographed images are subjected to a trapezoidal process and superimposed on two background images to generate a display image. The graphic processor performs the following processes.

(First Process): The graphic processor reads six photographed images (refer to FIG. 9(a)) after image processing stored in the DRAM, generates six trapezoidal images (refer to FIG. 9(b)) obtained by performing a trapezoidal process on the read images, and writes the six trapezoidal images to the DRAM again.

(Second Process): The graphic processor reads two background images (refer to FIG. 9(c)) stored in the DRAM, superimposes a background image 2 on a background image 1 to generate one new background image (refer to FIG. 9(d)), and writes the generated background image to the DRAM again.

(Third Process): The graphic processor reads the six trapezoidal images and the one new background image stored in the DRAM, superimposes the six trapezoidal images on the new background image one by one to generate display images (refer to FIG. 9(e)), and writes the display images to the DRAM again.

Then, the display processing unit reads the display images stored in the DRAM and displays the display images on the display device. As described above, when the graphic processor performs the respective processes, access to the DRAM is performed. Therefore, the DRAM band is suppressed, and thus it is not possible to ensure a desired frame rate of the display image.

Moreover, for example, in the case of allowing the background image 2 and the six photographed images after the image processing to be translucent, and generating a display image in which the background image 1 is seen below the six trapezoidal images and the background image 2, the superimposition process based on the alpha blending process is necessary in addition to the aforementioned process of the graphic processor. Therefore, a processing time of the graphic processor may be further increased, and it may be very difficult to ensure a desired frame rate of the display image.

### SUMMARY

The present invention provides an image display apparatus and an image display method, capable of preventing the suppression of a DRAM band even when a graphic process performed by a graphic processer is increased.

An image display apparatus, which displays a display image obtained by graphically processing an input image stored in an image storage unit connected to a common bus, may include: a graphic processing unit that has a function of performing a first and second graphic processes for processing the input image, the graphic processing unit outputting any one of an image obtained by performing the first graphic process on the input image acquired from the image storage unit and an image obtained by performing the second graphic process subsequently to the first graphic process to the image storage unit as a processed image so that the image storage unit stores the processed image; a display processing unit that has a function equal to the function of performing the second graphic process, the display processing unit outputting, as the display image, any one of the processed image acquired from the image storage unit and an image obtained by performing a process equal to the second graphic process on the processed image; and a switching control unit that switches a processing unit for performing the second graphic process to any one of the graphic processing unit and the display processing unit based on a predetermined condition.

The second graphic process may include an alpha blending process, and may be a superimposition process for superimposing the image obtained by performing the first graphic process and the input image acquired from the image storage unit.

The predetermined condition may be one or a plurality of threshold values of a display speed when the display image is displayed, the number of pixels of the display image, and the number of images to be subject to the superimposition process. The switching control unit may allow the superimposition process to be performed by the graphic processing unit when the threshold value is less than a predetermined value, and allows the superimposition process to be performed by the display processing unit when the threshold value is greater than the predetermined value.

When the superimposition process is performed by the display processing unit, the graphic processing unit may add transparency data to the image obtained by performing the first graphic process, and store the image with the transparency data in the image storage unit as the processed image, the transparency data representing transparency of each pixel of the image obtained by performing the first graphic process, and the display processing unit may output an image, which is obtained by superimposing the processed image and the input image acquired from the image storage unit based on the transparency data added to the processed image acquired from the image storage unit, as the display image.

When the superimposition process is performed by the graphic processing unit, the graphic processing unit may store an image, which is obtained by superimposing the image obtained by performing the first graphic process and the input image acquired from the image storage unit, in the image storage unit as the processed image subsequently to the first graphic process, and the display processing unit may output the processed image acquired from the image storage unit as the display image.

In a case in which the predetermined condition is the threshold value of the display speed when the display image is displayed, the switching control unit may allow the superimposition process to be performed by the graphic processing unit if the display speed when the display image is displayed is lower than the predetermined threshold value of the display speed, and allow the superimposition process to be performed by the display processing unit if the display speed is higher than the predetermined threshold value of the display speed.

In a case in which the predetermined condition is the threshold value of the number of pixels of the display image, the switching control unit may allow the superimposition process to be performed by the graphic processing unit when the number of pixels of the display image is less than the predetermined threshold value of the number of pixels, and allow the superimposition process to be performed by the display processing unit when the number of pixels of the display image is greater than the predetermined threshold value of the number of pixels.

In a case in which the predetermined condition is the threshold value of the number of images to be subject to the superimposition process, the switching control unit may allow the superimposition process to be performed by the graphic processing unit when the number of images to be subject to the superimposition process is less than the predetermined threshold value of the number of images to be subject to the superimposition process, and allow the superimposition process to be performed by the display processing unit when the number of images to be subject to the superimposition process is greater than the predetermined threshold value of the number of images to be subject to the superimposition process.

An image display method of an image display apparatus, which displays a display image obtained by graphically processing an input image stored in an image storage unit connected to a common bus, may include: a graphic processing step of executing a function of performing a first graphic process for processing the input image and a function of performing a second graphic process, and outputting any one of an image obtained by performing the first graphic process on the input image acquired from the image storage unit and an image obtained by performing the second graphic process subsequently to the first graphic process to the image storage unit as a processed image for storage; a display processing step of executing a function equal to the function of performing the second graphic process, and outputting, as the display image, any one of the processed image acquired from the image storage unit and an image obtained by performing a process equal to the second graphic process on the processed image; and a switching control step of switching a processing step for performing the second graphic process to any one of the graphic processing step and the display processing step based on a predetermined condition.

According to the present invention, even when the graphic process performed by the graphic processer is increased, it is possible to prevent the suppression of the DRAM band.

### BRIEF DESCRIPTION OF THE DRAWINGS

The above features and advantages of the present invention will be more apparent from the following description of certain preferred embodiments taken in conjunction with the accompanying drawings, in which:

FIG. 1 is a block diagram illustrating a schematic configuration of an image display apparatus in accordance with a first preferred embodiment of the present invention;

FIG. 2 is a block diagram illustrating a schematic configuration of a display processing unit in the image display apparatus in accordance with the first preferred embodiment of the present invention;

FIG. 3 is a diagram illustrating a switching of a processing block for performing a superimposition process in the image display apparatus in accordance with the first preferred embodiment of the present invention;

FIG. 4 is a diagram schematically illustrating an example of a process of a graphic processor when the image display apparatus in accordance with the first preferred embodiment performs first display;

FIG. 5 is a diagram schematically illustrating an example of a process of a display processing unit when the image display apparatus in accordance with the first preferred embodiment performs the first display;

FIG. 6 is a diagram schematically illustrating an example of the process of the graphic processor when the image display apparatus in accordance with the first preferred embodiment performs second display;

FIG. 7 is a diagram schematically illustrating an example of the process of the display processing unit when the image display apparatus in accordance with the first preferred embodiment performs the second display;

FIG. 8 is a diagram schematically illustrating an example of a display process when the image display apparatus in accordance with the first preferred embodiment performs third display; and

FIG. 9 is a diagram schematically illustrating an example of a display process in an image display apparatus in accordance with the related art.

### DETAILED DESCRIPTION OF THE PREFERRED EMBODIMENTS

The present invention will be now described herein with reference to illustrative preferred embodiments. Those skilled in the art will recognize that many alternative preferred embodiments can be accomplished using the teaching of the present invention and that the present invention is not limited to the preferred embodiments illustrated for explanatory purpose.

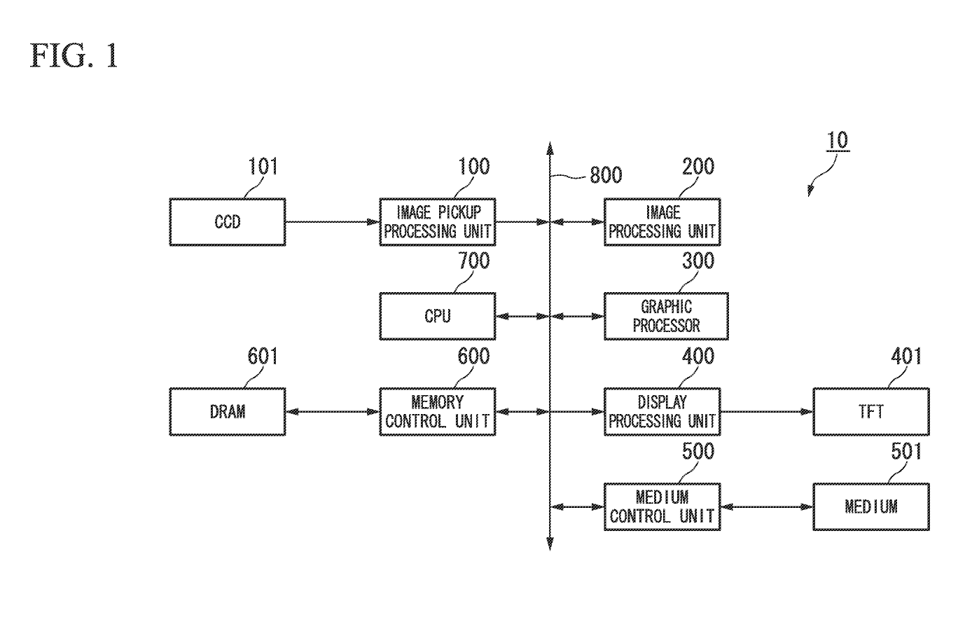

FIG. 1 is a block diagram illustrating a schematic configuration of an image display apparatus in accordance with the first preferred embodiment of the present invention. FIG. 1 illustrates a case in which the image display apparatus of the first preferred embodiment is a digital camera. In FIG. 1, a digital camera 10 includes a charge coupled device (CCD) 101, an image pickup processing unit 100, an image processing unit 200, a graphic processor 300, a display processing unit 400, a TFT 401, a medium control unit 500, a medium 501, a memory control unit 600, a DRAM 601, and a CPU 700.

The image pickup processing unit 100, the image processing unit 200, the graphic processor 300, the display processing unit 400, the medium control unit 500, the memory control unit 600, and the CPU 700 in the digital camera 10 are connected to a data bus 800, read data from the DRAM 601 connected to the memory control unit 600 through the data bus 800, and write data to the DRAM 601. At this time, each processing block connected to the data bus 800 accesses the DRAM 601 through DMA.

The CCD 101 is an image sensor which photoelectrically converts an optical image of an object formed by a lens (not illustrated). The CCD 101 outputs an image signal (hereinafter referred to as an “input image”) corresponding to object light to the image pickup processing unit 100. In addition, the digital camera 10 may be provided with a complementary metal-oxide semiconductor (CMOS) image sensor instead of the CCD 101.

The image pickup processing unit 100 is a processing block which performs an image capturing process, such as defect correction or shadowing correction, on the input image input from the CCD 101, and writes an image (hereinafter referred to as an “imaged image”) obtained through the image capturing process to the DRAM 601.

The image processing unit 200 is a processing block which reads the imaged image stored in the DRAM 601, and performs various image capturing processes such as noise removal, a YC exchange process, a resizing process, or a JPEG compression process, thereby generating an image for recording (hereinafter referred to as a “photographed image”). The image processing unit 200 writes the generated photographed image to the DRAM 601 again.

The graphic processor 300 is a processing block which reads the photographed image stored in the DRAM 601, and performs various graphic processes such as a polygon process, a superimposition process, a hidden surface process, or a shadowing process, thereby generating an image for display (hereinafter referred to as a “display image”). The graphic processor 300 writes the generated display image to the DRAM 601 again.

The display processing unit 400 is a processing block which reads the display image stored in the DRAM 601, and outputs the read display image to the TFT 401. Furthermore, it is possible for the display processing unit 400 to read an image stored in the DRAM 601, perform a superimposition process, which is the same as the superimposition process of the graphic processor 300, and output a superimposed image to the TFT 401 as a display image.

The TFT 401 is a display device (a TFT liquid crystal display) which displays an image corresponding to the display image input from the display processing unit 400. In addition, the digital camera 10 may be provided with a display device such as an organic electroluminescence (EL) display instead of the TFT 401.

The medium control unit 500 is a processing block which reads the photographed image stored in the DRAM 601, and records the photographed image on the medium 501. Furthermore, the medium control unit 500 is also a processing block which reads the photographed image recorded on the medium 501, and writes the read photographed image to the DRAM 601.

The medium 501 is recording medium such as a memory card, and records the photographed image output from the medium control unit 500. Furthermore, the recorded photographed image is read by the medium control unit 500. In addition, in FIG. 1, the medium 501 is also an element of the digital camera 10. However, the medium 501 may be detachable from the digital camera 10.

The memory control unit 600 not only adjusts access requests from the plurality of processing blocks in the digital camera 10, which are connected to the data bus 800, to the DRAM 601, but also controls data writing to the DRAM 601 to which it is connected and data reading from the DRAM 601.

Access to the DRAM 601 is controlled by the memory control unit 600, so that the DRAM 601 stores various types of data in the processes of the respective processing blocks in the digital camera 10.

The CPU 700 controls the elements of the digital camera 10, that is, the whole of the digital camera 10. Furthermore, the CPU 700 switches the processing block which performs the superimposition process. In more detail, the CPU 700 switches whether the superimposition process is performed by the graphic processor 300 or the display processing unit 400. In addition, a detailed description for a method by which the CPU 700 switches the processing block for performing the superimposition process will be described later.

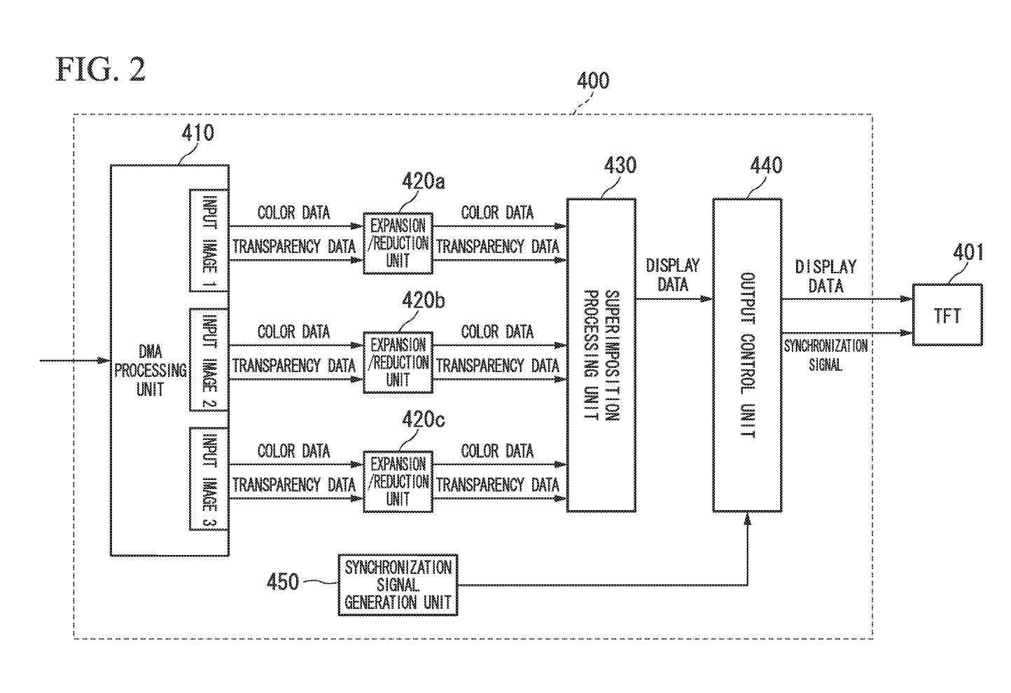

Next, a description will be provided for a configuration of the display processing unit 400 which provides an image to a user (a photographer) in the slide show function and the like of the digital camera 10 of the first preferred embodiment. FIG. 2 is a block diagram illustrating a schematic configuration of the display processing unit 400 in the digital camera 10 which is the image display apparatus in accordance with the first preferred embodiment of the present invention. FIG. 2 also illustrates the TFT 401 which is a display device provided in the digital camera 10.

In FIG. 2, the display processing unit 400 includes a DMA processing unit 410, a plurality of expansion/reduction units 420a to 420c, a superimposition processing unit 430, an output control unit 440, and a synchronization signal generation unit 450. The display processing unit 400 reads a plurality of images from the DRAM 601, performs a superimposition process on the read image, and then outputs the processed image to the TFT 401 as a display image. FIG. 2 illustrates the configuration of the display processing unit 400 which processes three images. To this end, the display processing unit 400 is provided with the three expansion/reduction units 420a to 420c. In addition, in the following description, when any one of the three expansion/reduction units 420a to 420c is indicated, it will be referred to as an “expansion/reduction unit 420.”

In addition, the superimposition process in the display processing unit 400 is the same as the superimposition process including the alpha blending process in the graphic processor 300 as described above. However, the number of images to be superimposed may be different from that in the graphic processor 300. In this case, it is preferable that the display processing unit 400 be provided with the same number of expansion/reduction units 420 as the number of images to be superimposed.

The DMA processing unit 410 is a block which acquires (reads) the original image (hereinafter referred to as an “input image”), such as the display image or the background image from the DRAM 601, which is to be displayed on the TFT 401 by the DMA access. The input image may include transparency data representing the transparency of each pixel of an image, in addition to color data such as RGB or YCrCb. Thus, the display processing unit 400 processes various formats of input images such as “RGB with transparency data,” “YCrCb with transparency data,” “RGB with no transparency data,” or “YCrCb with no transparency data.”

When acquiring the input image from the DRAM 601, the DMA processing unit 410 outputs a DMA access request to the DRAM 601 to the memory control unit 600. After the DMA access request is accepted in the memory control unit 600, the DMA processing unit 410 reads the input image from the DRAM 601 through the memory control unit 600. Then, the DMA processing unit 410 outputs the read input image to the expansion/reduction unit 420.

Each of the expansion/reduction units 420a to 420c is a block which performs an expansion process or a reduction process on the input image input from the DMA processing unit 410. An image size, such as the number of vertical and horizontal pixels of the input image, is designated to each of the expansion/reduction units 420a to 420c. Each of the expansion/reduction units 420a to 420c outputs an image, which has been subject to the expansion/reduction process according to the designated image size of the input image, to the superimposition processing unit 430.

The superimposition processing unit 430 is a block which superimposes respective input images through the superimposition process including the alpha blending process the same as in the graphic processor 300, and generates one display image. When the superimposition processing unit 430 generates the display image, the superimposition processing unit 430 generates display data by superimposing color data of the respective input images based on transparency data included in the respective input images. In addition, a display area for displaying the input image is designated to the superimposition processing unit 430. Furthermore, the superimposition processing unit 430 performs the superimposition process of the respective input images according to the designated display area. The superimposition processing unit 430 outputs a superimposed display image (display data) to the output control unit 440.

The synchronization signal generation unit 450 is a block which generates a synchronization signal when the display image is displayed on the TFT 401. The synchronization signal generation unit 450 outputs the generated synchronization signal of the TFT 401 to the output control unit 440.

The output control unit 440 outputs the display image (display data) input from the superimposition processing unit 430 to the TFT 401 at a timing of the synchronization signal input from the synchronization signal generation unit 450. Therefore, the TFT 401 displays an image corresponding to the display image (display data) input from the output control unit 440 in the display processing unit 400.

As described above, in the digital camera 10 of the first preferred embodiment, the display processing unit 400 also has a function of performing the superimposition process including the alpha blending process the same as in the graphic processor 300.

In addition, when the input image acquired from the DRAM 601 by the DMA processing unit 410 is a display image, it is possible for the display processing unit 400 to output the acquired display image to the TFT 401 without performing various processes, such as the expansion/reduction process or the superimposition process, on the input image. In this case, the CPU 700 controls (switches) whether various processes are performed on the input image, which has been acquired from the DRAM 601 by the DMA processing unit 410, in the display processing unit 400, and whether any one of the expansion/reduction process and the superimposition process or both of them are performed. Furthermore, the CPU 700 also controls (switches) whether the superimposition process is performed by the graphic processor 300.

Hereinafter, a description will be provided for a method by which the CPU 700 switches various processes (in the following description, also referred to as a “superimposition process”) such as the superimposition process by the graphic processor 300 or the expansion/reduction process or the superimposition process by the display processing unit 400. The CPU 700 switches whether the superimposition process is performed by the graphic processor 300 or the display processing unit 400 in consideration of the DRAM band, a processing time of the graphic process in the graphic processor 300, and the like. In further detail, when a frame rate of a display image to be displayed on the TFT 401, the number of display pixels of the TFT 401, and the number of images to be superimposed are less than a predetermined threshold value, the CPU 700 switches the superimposition process to be performed by the graphic processor 300. When the values are greater than the predetermined threshold value, the CPU 700 switches the superimposition process to be performed by the display processing unit 400.

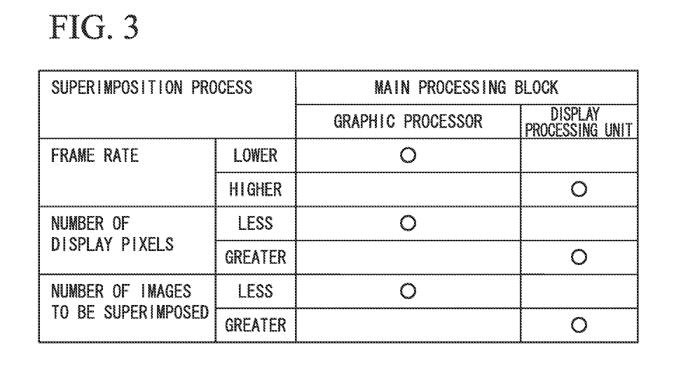

FIG. 3 is a diagram collectively illustrating the switching of the processing block for performing the superimposition process in the digital camera 10 which is the image display apparatus in accordance with the first preferred embodiment of the present invention. When the frame rate of the display image to be displayed on the TFT 401 is lower than a predetermined frame rate, the CPU 700 switches the superimposition process to be performed by the graphic processor 300. Meanwhile, when the frame rate of the display image to be displayed on the TFT 401 is higher than the predetermined frame rate, the CPU 700 switches the superimposition process to be performed by the display processing unit 400. For example, when the frame rate is lower than 15 frames (a display speed is slow), the CPU 700 switches the superimposition process to be performed by the graphic processor 300. Meanwhile, when the frame rate is higher than the 15 frames (the display speed is fast), the CPU 700 switches the superimposition process to be performed by the display processing unit 400.

Furthermore, when the number of display pixels of the TFT 401 is less than a predetermined number of display pixels, the CPU 700 switches the superimposition process to be performed by the graphic processor 300. Meanwhile, when the number of display pixels of the TFT 401 is greater than the predetermined number of display pixels, the CPU 700 switches the superimposition process to be performed by the display processing unit 400. For example, when the number of display pixels is less than one hundred thousand pixels, the CPU 700 switches the superimposition process to be performed by the graphic processor 300. Meanwhile, when the number of display pixels is greater than one hundred thousand pixels, the CPU 700 switches the superimposition process to be performed by the display processing unit 400.

Furthermore, when the number of images to be superimposed is less than a predetermined number, the CPU 700 switches the superimposition process to be performed by the graphic processor 300. Meanwhile, when the number of images to be superimposed is greater than the predetermined number, the CPU 700 switches the superimposition process to be performed by the display processing unit 400. For example, when the number of images to be superimposed is less than five images, the CPU 700 switches the superimposition process to be performed by the graphic processor 300. Meanwhile, when the number of images to be superimposed is greater than five images, the CPU 700 switches the superimposition process to be performed by the display processing unit 400.

As described above, in the digital camera 10 of the first preferred embodiment, when the DRAM band is estimated to be suppressed, or a processing time required in the graphic process of the graphic processor 300, for example, is estimated to exceed the synchronization of the synchronization signal of the TFT 401, the superimposition process, which is a part of the graphic process of the graphic processor 300, is allowed to be shared by the display processing unit 400. Therefore, it is possible to avoid the suppression of the DRAM band or an increase in the processing time of the graphic processor 300.

### First Display Process

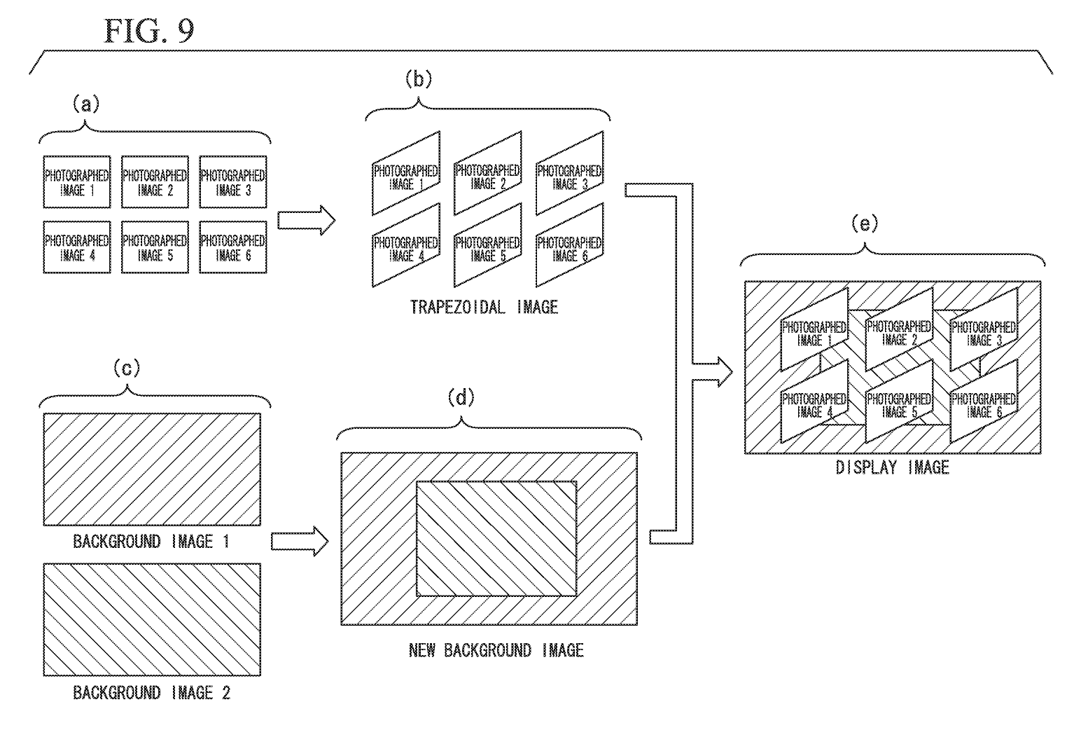

Next, a description will be provided for an example of a process when the graphic process of the graphic processor 300 is allowed to be shared by the graphic processor 300 and the display processing unit 400 under the control of the digital camera 10 of the first preferred embodiment. In the first display process, a description will be provided for a case in which the same display image as in an example of the display process in the image display apparatus in accordance with the related art illustrated in FIG. 9 is generated. That is, a description will be provided for a case of allowing a graphic process for performing a trapezoidal process on six photographed images and superimposing the resultant images on two background images to generate a display image to be shared by the graphic processor 300 and the display processing unit 400. In addition, in the digital camera 10, since the access to the DRAM 601, the image processing and the like, other than the display processes of the graphic processor 300 and the display processing unit 400, are the same as the processes of the image display apparatus in accordance with the related art, and a detailed description thereof will be omitted here.

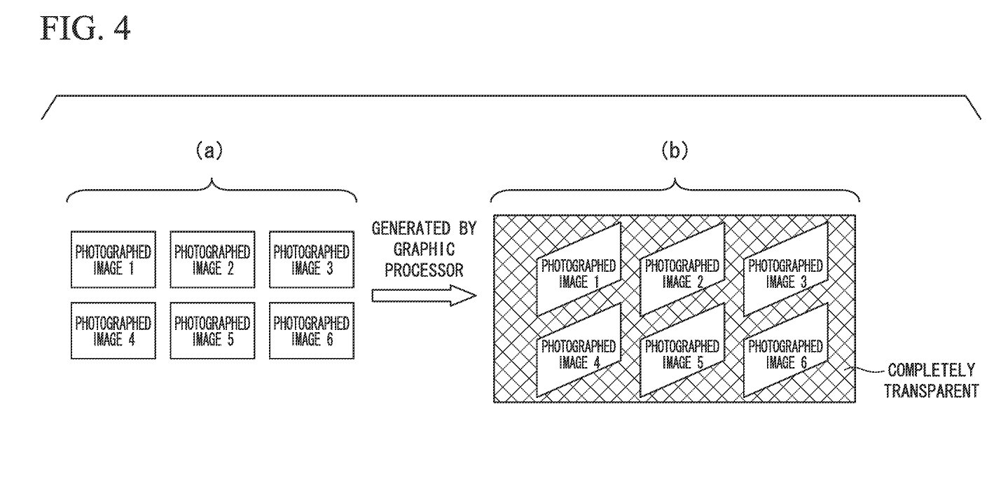

First, the display process by the graphic processor 300 will be described. FIG. 4 is a diagram schematically illustrating an example of the process of the graphic processor 300 when the digital camera 10 serving as the image display apparatus in accordance with the first preferred embodiment performs first display. In the first display process, the graphic processor 300 performs the following processes.

(First Process): The graphic processor 300 reads the six photographed images (refer to FIG. 4(a)) after the image processing from the DRAM 601, and generates the six trapezoidally processed trapezoidal images.

(Second Process): The graphic processor 300 generates one input image (refer to FIG. 4(b)) obtained by adding transparency data to the six generated trapezoidal images, and writes the generated input image to the DRAM 601 again.

Then, the display processing unit 400 reads the input image stored in the DRAM 601, and displays the read image on the TFT 401. As described above, the graphic processor 300 performs only a process for generating the rectangular input image with the transparency data, which can be processed by the display processing unit 400. Therefore, access from the graphic processor 300 to the DRAM 601 is reduced, so that it is possible to avoid the suppression of the DRAM band.

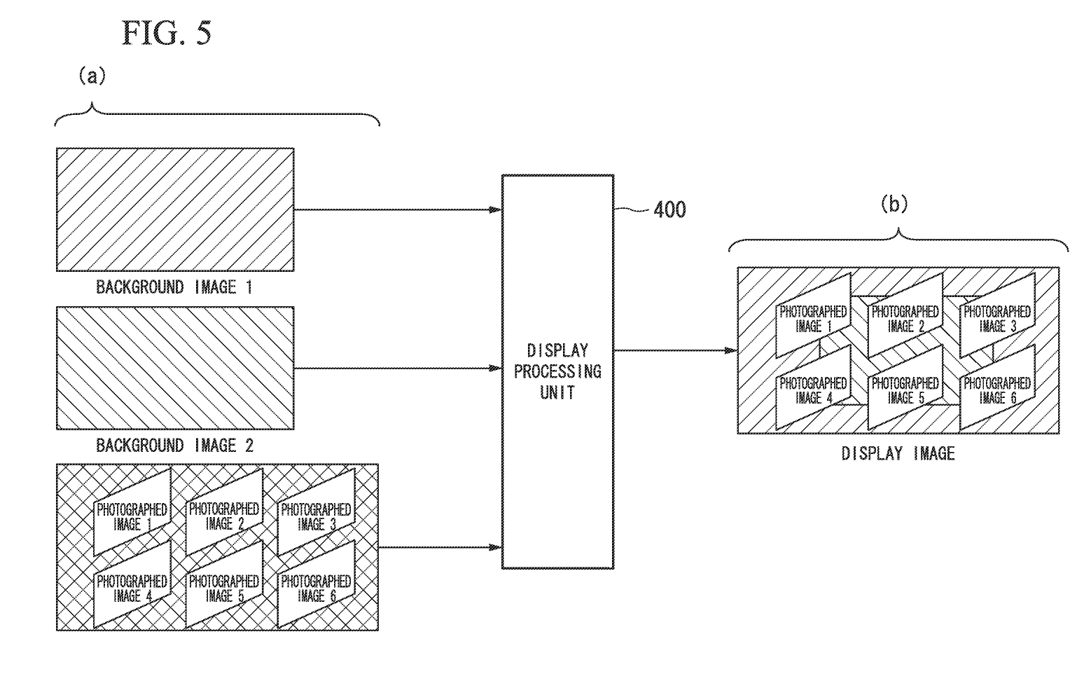

Next, the display process by the display processing unit 400 will be described. FIG. 5 is a diagram schematically illustrating an example of the process of the display processing unit 400 when the digital camera 10 serving as the image display apparatus in accordance with the first preferred embodiment performs the first display. In the first display process, the display processing unit 400 performs the following processes subsequently to the display process by the graphic processor 300. In addition, in the following processes, it is assumed that the expansion/reduction process by the expansion/reduction unit 420 is not performed.

(First Process): The DMA processing unit 410 reads the two background images stored in the DRAM 601 and the input image generated by the graphic processor 300 (refer to FIG. 5a), and outputs the read images to the expansion/reduction unit 420. Then, each expansion/reduction unit 420 outputs the two input background images and the input image to the superimposition processing unit 430.

(Second Process): The superimposition processing unit 430 superimposes the background image 2 on the input background image 1 and superimposes the input image to generate one display image (refer to FIG. 5b), and outputs the display image to the output control unit 440.

(Third Process): The output control unit 440 outputs the display image, which is input from the superimposition processing unit 430, to the TFT 401 at a timing of the synchronization signal input from the synchronization signal generation unit 450.

As described above, the display processing unit 400 superimposes the input image generated by the graphic processor 300 on the two background images stored in the DRAM 601, and outputs the superimposed display image to the TFT 401. That is, the display processing unit 400 performs processes corresponding to the “process for generating one new background image obtained by superimposing the background image 2 on the background image 1” and the “process for generating the display image obtained by superimposing the six trapezoidal images on the new background image one by one,” which are performed by the graphic processor provided in the image display apparatus in accordance with the related art. Therefore, it is possible to reduce (attenuate) a processing load of the graphic process performed by the graphic processor 300.

As described above, in the digital camera 10, a series of processes related to the display process are shared by the graphic processor 300 and the display processing unit 400. Therefore, it is possible to avoid the suppression of the DRAM band or an increase in the processing time of the graphic processor 300. Consequently, it is possible to implement the display of a display image having a desired frame rate.

### Second Display Process

The digital camera 10 may have a so-called live view function of continuously providing a user (a photographer) with input images continuously obtained from the CCD 101. In this case, the image processing unit 200 reads the imaged image stored in the DRAM 601, performs image processing for display on the read image to generate an image for display (hereinafter referred to as a “through image”), and writes the through image to the DRAM 601 again. Normally, the through image includes no transparency data. Furthermore, the graphic processor 300 graphically processes a menu image of the digital camera 10. In the digital camera 10 of the first preferred embodiment, even in such a case, the graphic process of the graphic processor 300 can be shared by the graphic processor 300 and the display processing unit 400.

Next, a description will be provided for an example of another process when the graphic process of the graphic processor 300 is shared by the graphic processor 300 and the display processing unit 400 under the control of the digital camera 10 of the first preferred embodiment. In the second display process, a description will be provided for a case of allowing a graphic process for generating a display image by performing a trapezoidal process on three menu images and superimposing the resultant images on a through image to be shared by the graphic processor 300 and the display processing unit 400. In addition, also in the second display process, since the access to the DRAM 601, the image processing and the like, other than the display processes of the graphic processor 300 and the display processing unit 400 of the digital camera 10, are the same as the processes of the image display apparatus in accordance with the related art, and a detailed description thereof will be omitted here.

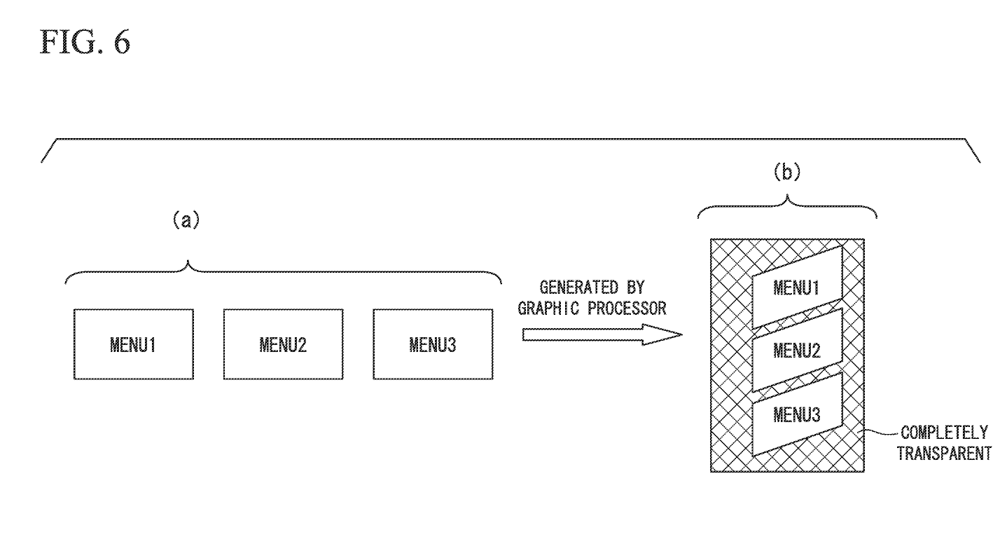

First, the display process by the graphic processor 300 will be described. FIG. 6 is a diagram schematically illustrating an example of the process of the graphic processor 300 when the digital camera 10 serving as the image display apparatus in accordance with the first preferred embodiment performs second display. In the second display process, the graphic processor 300 performs the following processes.

(First Process): The graphic processor 300 reads the three menu images (refer to FIG. 6a) stored in the DRAM 601, and generates the three trapezoidally processed trapezoidal menu images.

(Second Process): The graphic processor 300 generates one input image (refer to FIG. 6b) obtained by adding transparency data to the three generated trapezoidal menu images, and writes the generated input image to the DRAM 601 again.

Then, the display processing unit 400 reads the input image stored in the DRAM 601, and displays the read image on the TFT 401. As described above, the graphic processor 300 performs only a process for generating the rectangular input image with the transparency data, which can be processed by the display processing unit 400. Therefore, access from the graphic processor 300 to the DRAM 601 is reduced, so that it is possible to avoid the suppression of the DRAM band.

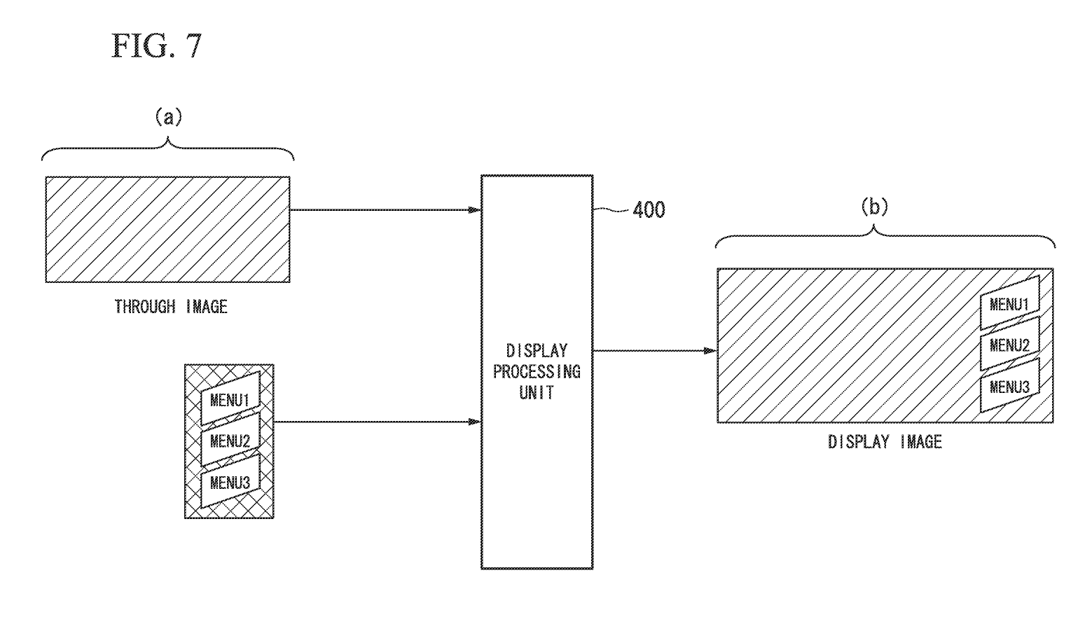

Next, the display process by the display processing unit 400 will be described. FIG. 7 is a diagram schematically illustrating an example of the process of the display processing unit 400 when the digital camera 10 serving as the image display apparatus in accordance with the first preferred embodiment performs the second display. In the second display process, similarly to the first display process, the display processing unit 400 performs the following processes subsequently to the display process by the graphic processor 300. In addition, in the following processes, a description will be provided for a case in which an image size and a display area of an input image including the menu images are designated to the display processing unit 400, and a display process is performed according to the designated image size and display area.

(First Process): The DMA processing unit 410 reads the one through image stored in the DRAM 601 and the input image generated by the graphic processor 300 (refer to FIG. 7a), and outputs the read images to the expansion/reduction unit 420. Hereinafter, it is assumed that the DMA processing unit 410 outputs the through image read from the DRAM 601 to the expansion/reduction unit 420a and outputs the input image to the expansion/reduction unit 420b.

(Second Process): The expansion/reduction unit 420a outputs the one input through image to the superimposition processing unit 430. Furthermore, the expansion/reduction unit 420b performs the expansion/reduction process on the input image according to the designated image size, and outputs the input image after the expansion/reduction process to the superimposition processing unit 430.

(Third Process): The superimposition processing unit 430 generates one display image (refer to FIG. 7b) by superimposing the input image after the expansion/reduction process input from the expansion/reduction unit 420b on the display area designated to the through image input from the expansion/reduction unit 420a, and outputs the display image to the output control unit 440.

(Fourth Process): The output control unit 440 outputs the display image, which is input from the superimposition processing unit 430, to the TFT 401 at a timing of the synchronization signal input from the synchronization signal generation unit 450.

As described above, the display processing unit 400 superimposes the input image generated by the graphic processor 300 on the one through image stored in the DRAM 601, and outputs the superimposed display image to the TFT 401. Therefore, it is possible to reduce (attenuate) a processing load of the graphic process performed by the graphic processor 300.

As described above, according to the digital camera 10, in the display process associated with the through image, a series of processes related to the display process are shared by the graphic processor 300 and the display processing unit 400. Therefore, the suppression of the DRAM band or the processing load of the graphic processor 300 is reduced (attenuated), so that it is possible to implement the display of a display image (a through image) having a desired frame rate.

### Third Display Process

In the digital camera 10, when the menu image is superimposed on the through image, it is not necessary for the graphic processor 300 to graphically process the whole area of the menu image superimposed on the through image in each frame. That is, the graphic processor 300 graphically processes only a part of the menu image, so that it is possible to change the menu image. Therefore, it is possible to further reduce (attenuate) a processing load of the graphic process for the menu image by the graphic processor 300.

Next, a description will be provided for an example of a process when the graphic process of the graphic processor 300 is shared by the graphic processor 300 and the display processing unit 400, and is reduced (attenuated) under the control of the digital camera 10 of the first preferred embodiment. In the third display process, a description will be provided for a case in which when a graphic process for generating a display image superimposed on a through image by performing a trapezoidal process on three menu images is allowed to be shared by the graphic processor 300 and the display processing unit 400 similarly to the second display process, one menu image is changed in a subsequent frame. In addition, also in the third display process, since the access to the DRAM 601, the image processing and the like, other than the display processes of the graphic processor 300 and the display processing unit 400 of the digital camera 10, are the same as the processes of the image display apparatus in accordance with the related art, a detailed description thereof will be omitted here.

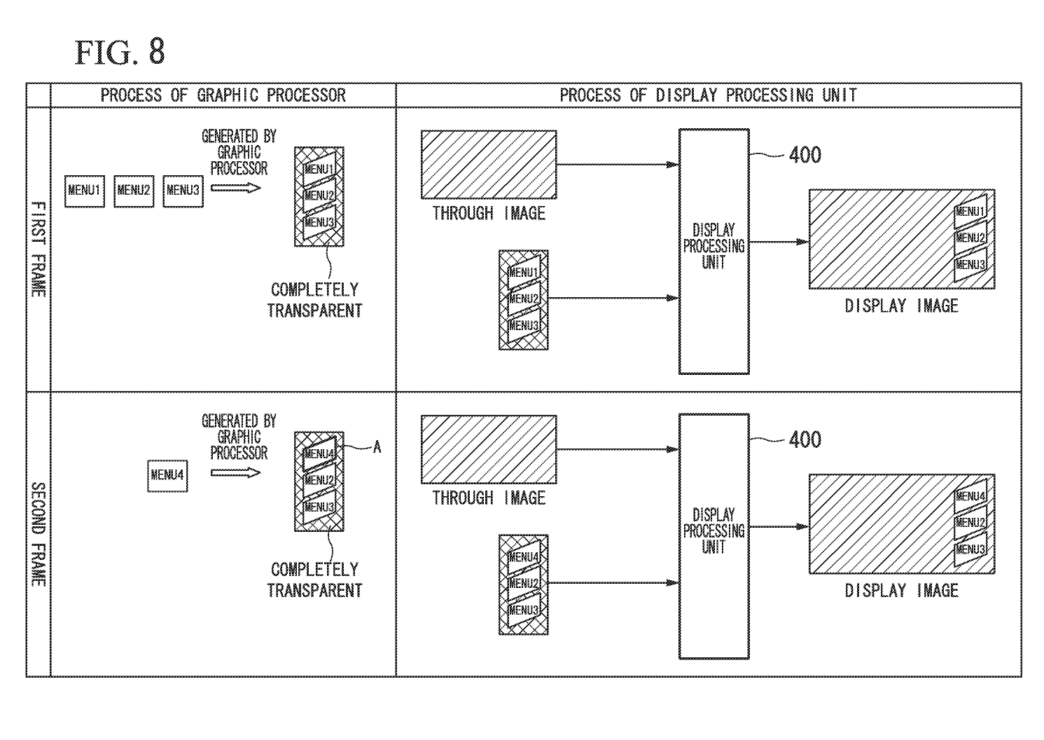

FIG. 8 is a diagram schematically illustrating an example of a display process when the digital camera 10 serving as the image display apparatus in accordance with the first preferred embodiment performs third display. FIG. 8 illustrates the processes of the graphic processor 300 and the display processing unit 400 when a display process of a second frame is performed subsequently to a display process of a first frame. In addition, since the display processes of the graphic processor 300 and the display processing unit 400 in the display process of the first frame are the same as those in the second display process, a detailed description thereof will be omitted here.

The display processes of the graphic processor 300 and the display processing unit 400 in the display process of the second frame will be described. In the second frame, it is assumed that a menu image “MENU 1” of the first frame is changed to a menu image “MENU 4” in the second frame. In the display process of the second frame of the third display process, the graphic processor 300 performs the following processes.

(First Process): The graphic processor 300 reads one menu image (“MENU 4” in FIG. 8a) stored in the DRAM 601 to be updated, and generates a trapezoidal menu image of “MENU 4.”

(Second Process): The graphic processor 300 rewrites (overwrites) data (a part of an area A illustrated in FIG. 8a) of an area of “MENU 1” in the input image written to the DRAM 601 in the first frame to data of the trapezoidal menu image of “MENU 4.”

As described above, only a part of the already generated input image is rewritten (overwritten), so that it is possible to update the input image to a new input image. Therefore, access from the graphic processor 300 to the DRAM 601 is reduced, so that it is possible to further avoid the suppression of the DRAM band.

Then, the display processing unit 400 reads the new input image stored in the DRAM 601 and displays the read input image on the TFT 401. In addition, since the display process in the display processing unit 400 is the same as the display process in the display processing unit 400 of the first frame, that is, the second display process, a detailed description thereof will be omitted here. In addition, in the display process of the display processing unit 400 of the second frame, the DMA processing unit 410 reads the one through image stored in the DRAM 601 and the input image updated by the graphic processor 300. However, it is not necessary for the display processing unit 400 (particularly, the DMA processing unit 410) to particularly recognize that the input image is updated.

As described above, when a part of the input image generated by the graphic processor 300 is updated, only a partial image to be updated by the graphic processor 300 is graphically processed, so that it is possible for the display processing unit 400 to superimpose the input image updated by the graphic processor 300 on the one through image stored in the DRAM 601 and to output the superimposed display image to the TFT 401.

As described above, according to the digital camera 10, in the display process associated with the through image, it is possible to further reduce (attenuate) a load of a series of processes related to the update of the input image performed by the graphic processor 300, and to improve a processing speed when the graphic processor 300 generates one input image. Therefore, the suppression of the DRAM band or a processing load of the graphic processor 300 is reduced (attenuated), so that it is possible to implement the display of a display image (a through image) having a desired frame rate.

As described above, according to the embodiment of the present invention, the display processing unit also has a partial function (a function of performing the superimposition process including the alpha blending in the embodiment of the present invention) of the graphic process of the graphic processor. Furthermore, between the two processing blocks having the same function, one of them is switched to perform the function in consideration of the DRAM band, a processing time of the graphic process in the graphic processor, and the like. Therefore, a series of processes related to the display process can be shared by the graphic processor and the display processing unit. Consequently, it is possible to prevent the suppression of the DRAM band or an increase in a processing load of the graphic processor, so that it is possible to easily implement the display of a display image having a desired frame rate.

In addition, in the first preferred embodiment, a function of the display processing unit 400, which is the same as that of the graphic processor 300, is a function of performing the superimposition process including the alpha blending. However, the function of the display processing unit 400, which is the same as that of the graphic processor 300, is not limited to the embodiment of the present invention. That is, if there are functions which can be processed by other processing blocks without problems and can prevent the suppression of the DRAM band, other than a function of performing the graphic process specialized in the graphic processor, it is possible to achieve a configuration in which a process is shared by the graphic processor and the display processing unit, regardless of the function of performing the graphic process.

Furthermore, in the first preferred embodiment, the display process is performed on the image data such as the photographed image, the background image, the through image, and the menu image. However, the image data to be subject to the display process is not limited to the embodiment of the present invention. For example, the display process may be shared and performed on data such as texture in the same manner.

While preferred embodiments of the present invention have been described and illustrated above, it should be understood that these are examples of the present invention and are not to be considered as limiting. Additions, omissions, substitutions, and other modifications can be made without departing from the scope of the present invention. Accordingly, the present invention is not to be considered as being limited by the foregoing description, and is only limited by the scope of the claims.

What is claimed is:

1. An image display apparatus, which displays a display image obtained by graphically processing an input image stored in an image storage unit connected to a common bus, the image display apparatus comprising:
a graphic processing unit that has a function of performing a first and second graphic processes for processing the input image, the graphic processing unit outputting any one of an image obtained by performing the first graphic process on the input image acquired from the image storage unit and an image obtained by performing the second graphic process subsequently to the first graphic process to the image storage unit as a processed image so that the image storage unit stores the processed image;
a display processing unit that has a function equal to the function of performing the second graphic process, the display processing unit outputting, as the display image, any one of the processed image acquired from the image storage unit and an image obtained by performing a process equal to the second graphic process on the processed image; and
a switching control unit that switches a processing unit for performing the second graphic process to any one of the graphic processing unit and the display processing unit based on a predetermined condition.

2. The image display apparatus according to claim 1, wherein the second graphic process includes an alpha blending process, and is a superimposition process for superimposing the image obtained by performing the first graphic process and the input image acquired from the image storage unit.

3. The image display apparatus according to claim 2, wherein
the predetermined condition is one or a plurality of threshold values of a display speed when the display image is displayed, the number of pixels of the display image, and the number of images to be subject to the superimposition process, and
the switching control unit allows the superimposition process to be performed by the graphic processing unit when the threshold value is less than a predetermined value, and allows the superimposition process to be performed by the display processing unit when the threshold value is greater than the predetermined value.

4. The image display apparatus according to claim 3, wherein,
when the superimposition process is performed by the display processing unit,
the graphic processing unit adds transparency data to the image obtained by performing the first graphic process, and stores the image with the transparency data in the image storage unit as the processed image, the transparency data representing transparency of each pixel of the image obtained by performing the first graphic process, and
the display processing unit outputs an image, which is obtained by superimposing the processed image and the input image acquired from the image storage unit based on the transparency data added to the processed image acquired from the image storage unit, as the display image.

5. The image display apparatus according to claim 3, wherein,
when the superimposition process is performed by the graphic processing unit,
the graphic processing unit stores an image, which is obtained by superimposing the image obtained by performing the first graphic process and the input image acquired from the image storage unit, in the image storage unit as the processed image subsequently to the first graphic process, and
the display processing unit outputs the processed image acquired from the image storage unit as the display image.

6. The image display apparatus according to claim 4, wherein,
when the superimposition process is performed by the graphic processing unit,
the graphic processing unit stores an image, which is obtained by superimposing the image obtained by performing the first graphic process and the input image acquired from the image storage unit, in the image storage unit as the processed image subsequently to the first graphic process, and
the display processing unit outputs the processed image acquired from the image storage unit as the display image.

7. The image display apparatus according to claim 3, wherein,
in a case in which the predetermined condition is the threshold value of the display speed when the display image is displayed, the switching control unit allows the superimposition process to be performed by the graphic processing unit if the display speed when the display image is displayed is lower than the predetermined threshold value of the display speed, and allows the superimposition process to be performed by the display processing unit if the display speed is higher than the predetermined threshold value of the display speed.

8. The image display apparatus according to claim 4, wherein,
in a case in which the predetermined condition is the threshold value of the display speed when the display image is displayed, the switching control unit allows the superimposition process to be performed by the graphic processing unit if the display speed when the display image is displayed is lower than the predetermined threshold value of the display speed, and allows the superimposition process to be performed by the display processing unit if the display speed is higher than the predetermined threshold value of the display speed.

9. The image display apparatus according to claim 5, wherein,
in a case in which the predetermined condition is the threshold value of the display speed when the display image is displayed, the switching control unit allows the superimposition process to be performed by the graphic processing unit if the display speed when the display image is displayed is lower than the predetermined threshold value of the display speed, and allows the superimposition process to be performed by the display processing unit if the display speed is higher than the predetermined threshold value of the display speed.

10. The image display apparatus according to claim 6, wherein,
in a case in which the predetermined condition is the threshold value of the display speed when the display image is displayed, the switching control unit allows the superimposition process to be performed by the graphic processing unit if the display speed when the display image is displayed is lower than the predetermined threshold value of the display speed, and allows the superimposition process to be performed by the display processing unit if the display speed is higher than the predetermined threshold value of the display speed.

11. The image display apparatus according to claim 3, wherein,
in a case in which the predetermined condition is the threshold value of the number of pixels of the display image, the switching control unit allows the superimposition process to be performed by the graphic processing unit when the number of pixels of the display image is less than the predetermined threshold value of the number of pixels, and allows the superimposition process to be performed by the display processing unit when the number of pixels of the display image is greater than the predetermined threshold value of the number of pixels.

12. The image display apparatus according to claim 4, wherein,
in a case in which the predetermined condition is the threshold value of the number of pixels of the display image, the switching control unit allows the superimposition process to be performed by the graphic processing unit when the number of pixels of the display image is less than the predetermined threshold value of the number of pixels, and allows the superimposition process to be performed by the display processing unit when the number of pixels of the display image is greater than the predetermined threshold value of the number of pixels.

13. The image display apparatus according to claim 5, wherein,
in a case in which the predetermined condition is the threshold value of the number of pixels of the display image, the switching control unit allows the superimposition process to be performed by the graphic processing unit when the number of pixels of the display image is less than the predetermined threshold value of the number of pixels, and allows the superimposition process to be performed by the display processing unit when the number of pixels of the display image is greater than the predetermined threshold value of the number of pixels.

14. The image display apparatus according to claim 6, wherein,
in a case in which the predetermined condition is the threshold value of the number of pixels of the display image, the switching control unit allows the superimposition process to be performed by the graphic processing unit when the number of pixels of the display image is less than the predetermined threshold value of the number of pixels, and allows the superimposition process to be performed by the display processing unit when the number of pixels of the display image is greater than the predetermined threshold value of the number of pixels.

15. The image display apparatus according to claim 3, wherein,
in a case in which the predetermined condition is the threshold value of the number of images to be subject to the superimposition process, the switching control unit allows the superimposition process to be performed by the graphic processing unit when the number of images to be subject to the superimposition process is less than the predetermined threshold value of the number of images to be subject to the superimposition process, and allows the superimposition process to be performed by the display processing unit when the number of images to be subject to the superimposition process is greater than the predetermined threshold value of the number of images to be subject to the superimposition process.

16. The image display apparatus according to claim 4, wherein,
in a case in which the predetermined condition is the threshold value of the number of images to be subject to the superimposition process, the switching control unit allows the superimposition process to be performed by the graphic processing unit when the number of images to be subject to the superimposition process is less than the predetermined threshold value of the number of images to be subject to the superimposition process, and allows the superimposition process to be performed by the display processing unit when the number of images to be subject to the superimposition process is greater than the predetermined threshold value of the number of images to be subject to the superimposition process.

17. The image display apparatus according to claim 5, wherein,
in a case in which the predetermined condition is the threshold value of the number of images to be subject to the superimposition process, the switching control unit allows the superimposition process to be performed by the graphic processing unit when the number of images to be subject to the superimposition process is less than the predetermined threshold value of the number of images to be subject to the superimposition process, and allows the superimposition process to be performed by the display processing unit when the number of images to be subject to the superimposition process is greater than the predetermined threshold value of the number of images to be subject to the superimposition process.

18. The image display apparatus according to claim 6, wherein,
in a case in which the predetermined condition is the threshold value of the number of images to be subject to the superimposition process, the switching control unit allows the superimposition process to be performed by the graphic processing unit when the number of images to be subject to the superimposition process is less than the predetermined threshold value of the number of images to be subject to the superimposition process, and allows the superimposition process to be performed by the display processing unit when the number of images to be subject to the superimposition process is greater than the predetermined threshold value of the number of images to be subject to the superimposition process.

19. An image display method of an image display apparatus, which displays a display image obtained by graphically processing an input image stored in an image storage unit connected to a common bus, the image display method comprising:
a graphic processing step of executing a function of performing a first graphic process for processing the input image and a function of performing a second graphic process, and outputting any one of an image obtained by performing the first graphic process on the input image acquired from the image storage unit and an image obtained by performing the second graphic process subsequently to the first graphic process to the image storage unit as a processed image for storage;
a display processing step of executing a function equal to the function of performing the second graphic process, and outputting, as the display image, any one of the processed image acquired from the image storage unit and an image obtained by performing a process equal to the second graphic process on the processed image; and
a switching control step of switching a processing step for performing the second graphic process to any one of the graphic processing step and the display processing step based on a predetermined condition.
